(19) United States
(12) Patent Application Publication
(10) Pub. No.: US 2026/0309147 A1
(43) Pub. Date: Oct. 8, 2026

(54) VOLUMETRIC VARIABLE DISPLACEMENT MACHINE

(71) Applicant: CASAPPA S.P.A., COLLECCHIO (PARMA) (IT)

(72) Inventors: Antonio LETTINI, PARMA (IT); MARCO GUIDETTI, PARMA (IT); Alessandro FANIGLIULO, FIDENZA (PARMA) (IT)

(21) Appl. No.: 18/998,343

(22) PCT Filed: Jun. 23, 2023
(86) PCT No.: PCT/IB2023/056498

§ 371 Date: Jan. 24, 2025

(30) Foreign Application Priority Data
Jul. 25, 2022 (IT) 102022000015621

(51) Int. Cl. F04B 51/00; F03C 1/28; F03C 1/40; F04B 49/06; F04B 49/12

(52) U.S. Cl. CPC F04B 51/00; F03C 1/0605; F03C 1/0678; F04B 49/06; F04B 49/12

(57) ABSTRACT

Volumetric variable displacement machine interacting with an operating fluid, the machine being a motor with axial pistons or a pump with axial pistons and including: i) means interacting with the operating fluid; ii) a housing casing housing means interacting with the operating fluid; iii) actuating means for regulating a displacement of the machine; iv) a control unit for controlling the actuating means; v) a detection sensor for detecting a parameter associated with the adopted displacement of the machine and operationally connected to the control unit; and vi) a protective casing protecting the control unit that is integrated into or physically constrained on the housing casing. The detection sensor is placed inside the protective casing.

### TECHNICAL FIELD

The present invention relates to a volumetric variable displacement machine interacting with an operating fluid.

### PRIOR ART

Variable displacement piston pumps are well known to better adapt their operation to different applications or uses. In order to vary the displacement, action is taken on the tilt relative to an axis of rotation of a plate to which one end of the pistons is connected.

These pumps are integrated into a system in which it is possible to determine the displacement instant by instant. In this regard an angular sensor is applied to a machine body.

This angular sensor sends the signal to a remote control unit which, depending on the information received, transmits a special command to a valve that allows the plate to be regulated fluid-dynamically.

The object of the present invention is to propose a volumetric variable displacement machine that allows an optimization of the wirings and a higher assembly speed.

### OBJECT OF THE INVENTION

The stated technical task and specified objects are substantially achieved by a volumetric variable displacement machine comprising the technical features disclosed in one or more of the appended claims.

### BRIEF DESCRIPTION OF THE DRAWINGS

Further characteristics and advantages of the present invention will become more apparent from the following indicative and therefore non-limiting description of a volumetric variable displacement machine as illustrated in the attached figures in which:

FIG. 1 shows a perspective view of a volumetric machine according to the present invention;

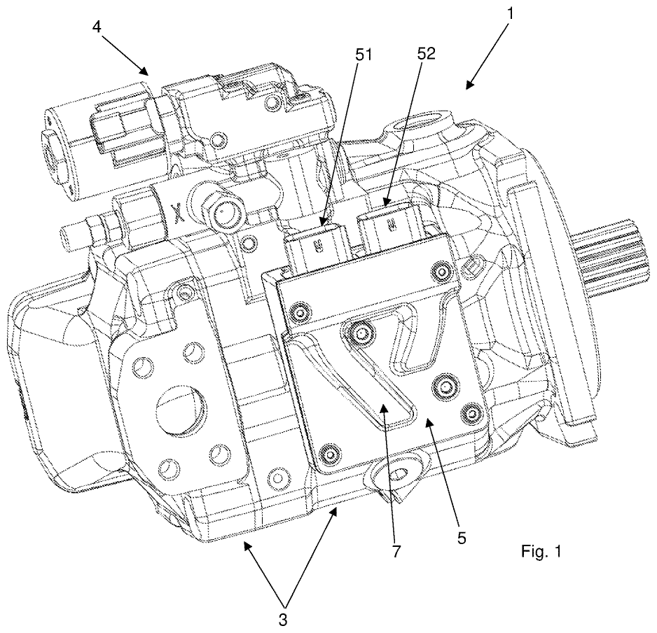

FIG. 2 shows the machine of FIG. 1 with some parts removed to better highlight others;

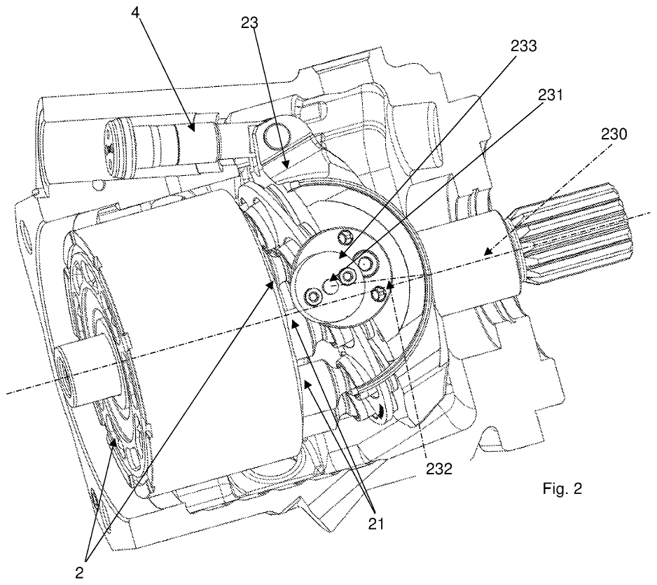

FIG. 3 shows a sectional view of the machine of FIG. 1;

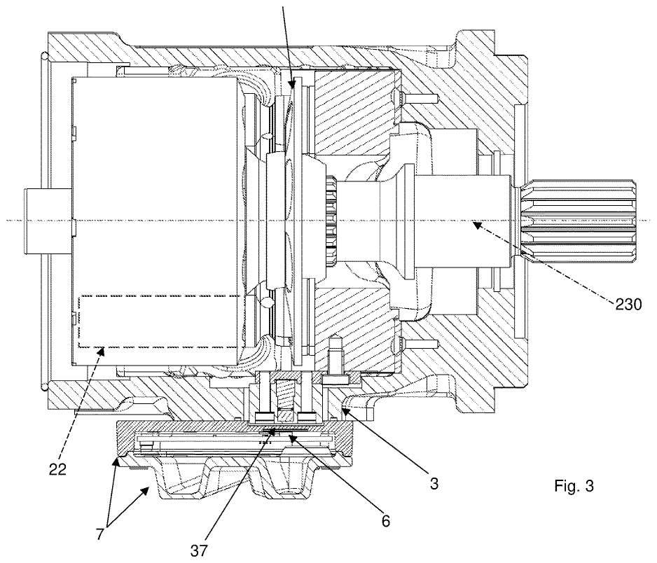

FIG. 4 shows an enlarged detail of FIG. 3.

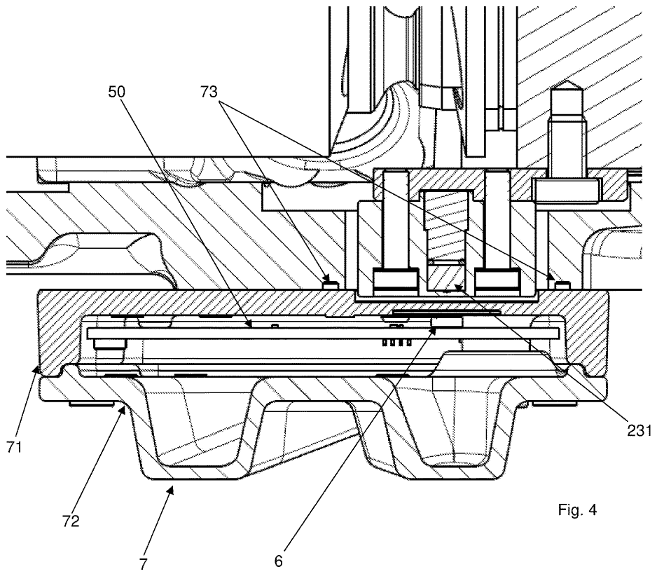

### DETAILED DESCRIPTION OF PREFERRED EMBODIMENTS OF THE INVENTION

In the attached figures, reference numeral 1 indicates a volumetric variable displacement machine interacting with an operating fluid. Typically the operating fluid is an incompressible fluid, e.g. oil. The machine 1 is a motor with axial pistons or a pump with axial pistons. Pumps with axial pistons have a plurality of pistons that are movable forwards and backwards along a direction parallel to that of an axis of rotation. The same can be said for the motors with axial pistons. In the case of a motor, the energy of the operating fluid is used to set in motion an element, typically a shaft, so as to be able to take advantage of the mechanical energy obtained; in the case of a pump, energy is used to set in motion an element (typically a shaft) that allows to the operating fluid a pressure jump.

The machine 1 comprises means 2 interacting with the operating fluid.

The machine 1 also comprises a housing casing 3 housing means 2 interacting with the operating fluid. Suitably the casing 3 can be defined in the technical field as “box” or “machine body” (and can be a single body or an assembly of more parts).

Suitably the pump with axial pistons or the motor with axial pistons in turn comprises:
a plurality of pistons 21 that are movable forwards and backwards along a common movement direction and rotatable around an axis of rotation 230 parallel to the movement direction (suitably the pistons 21 are movable forwards and backwards in corresponding cavities 22; suitably the axis of rotation 230 is an axis of rotation common to the pistons 21);
a structure 23 with variable tilt relative to the axis of rotation 230 for regulating a stroke of the pistons 21 and therefore the displacement of the machine 1.

A variation of the tilt of the structure 23 relative to the axis of rotation 230 results in a variation of the displacement (in the specific case reference is made to a variation of the tilt relative to the axis of rotation 230, but it would be equivalent to refer to a variation of the tilt relative to an imaginary plane orthogonal to said axis 230 or a vertical imaginary plane). Typically a variation of the tilt of the structure 23 relative to the axis 230 provides for rotating the structure 23 about an imaginary straight line 232. Said straight line 232 suitably extends along a direction orthogonal to that of the axis of rotation 230 (suitably the imaginary straight line 232 is orthogonal to the axis of rotation 230). The greater or lesser tilt of the structure 23 in fact results in a greater or lesser stroke of the pistons and therefore the displacement of the pump (hence the correlation between the angle of tilt of the structure 23 and the displacement). In the case where the machine 1 is a motor, the rotation of the pistons 21 about the axis of rotation 230 in turn drags the cavities 22 into rotation about the axis of rotation 230.

Advantageously the cavities 22 are integrated in a body which is thus dragged into rotation around the axis of rotation 230. In the case where the machine 1 is a pump it is the rotation of the cavities 22 that drags the pistons 21 into rotation around the axis 230. The structure 23 in technical jargon is referred to as a plate or oscillating plate. If the plate extends orthogonally to the axis of rotation 230, the displacement is zero. Increasing the tilt relative to the axis 230 increases the displacement.

The machine 1 comprises actuating means 4 for regulating a displacement of the machine. The actuating means 4 acts on said structure 23 with a variable tilt to regulate the displacement of the machine 1.

For example the actuating means 4 may comprise a regulator, for example they may comprise an electro-proportional regulator or a solenoid valve or other device (e.g. an electric motor) which regulates (fluid-dynamically or otherwise) the tilt of the structure 23 relative to the axis of rotation 230.

Suitably, by a solenoid valve is meant an electrically operated valve that modifies a flow as a function of an electrical signal. An electro-proportional regulator is a set of components, which can also include a solenoid valve, capable of regulating the displacement of the pump. An electro-proportional regulator is able to act on the displacement to make proportional adjustments to an electrical signal.

For example the pistons 21 are indirectly associated to the structure 23 by means of a piston guide plate which is rotatable about the axis of rotation 230 together with the pistons 21. By way of non-limiting example, the piston guide plate could be pushed towards the structure 23 by means of a spring.

The machine 1 comprises a control unit 5 for controlling the actuating means 4. Said control unit 5 sends for example an electrical signal to the actuating means 4 which regulates, for example fluid-dynamically, the tilt of the structure 23 relative to the axis of rotation 230. The actuating means 4 therefore allows to regulate the displacement of the machine 1 by receiving an electrical signal from the control unit 5.

The electro-proportional regulator or the solenoid valve or other device capable of regulating the tilt of the structure 23 relative to the axis 230 can perform different functions (e.g. regulate the pressure, the flow rate, the torque absorbed . . . ) by regulating the displacement of the pump in a proportional or discrete manner. In the same machine 1 there can be more regulators (or solenoid valves) that perform different functions.

The control unit 5 advantageously comprises a first and a second connector 51, 52. The control unit 5 is connected to the controller (for example to the electro-proportional controller) via the first connector 51, but it could also be connected directly with an outgoing cable (without connector).

The second connector 52 connects the control unit 5 of the pump to an additional control unit, typically external to the machine 1, for reading or sending data. Theoretically such a connection could also be absent (non-privileged solution).

The first and/or second connector 51, 52 could also control other electro-proportional regulators on the machine 1 and/or other valves and/or in general electrical components external to the machine 1, and/or read the signal from other sensors.

The control unit 5 may comprise an electronic board 50. Advantageously the control unit 5 and/or the board 50 can be assembled in two possible ways (for example by positioning the first and second connectors 51, 52 both upwards or both downwards or one upwards and the other downwards). Suitably, the sensor 6 is associated with the board 50. In particular the sensor 6 (i.e. the sensing element) is immovably connected to the board 50. Suitably the sensor 6 lies on a surface of the board 50 (for example it is directly connected). Suitably the sensor 6 is welded to the board 50.

The machine 1 comprises a sensor 6 for detecting a parameter associated with the adopted displacement of the machine 1. As better explained below this parameter is for example the tilt of the structure 23 relative to the axis of rotation 230. This sensor 6 is operatively connected to the control unit 5. The sensor 6 can therefore interact electrically with the control unit 5.

Advantageously the detection sensor 6 comprises/is an angular detection sensor that detects a variation of the tilt of the structure 23 relative to the axis of rotation 230.

Preferably the angular sensor is a Hall effect sensor. The angular sensor interacts remotely with a magnet 231 solidly constrained to said structure 23 to comprise the degree of tilt of the structure 23 relative to the axis of rotation 230. Depending on the relative position between the magnet and the angular sensor (in particular with Hall effect) the latter is able to determine the tilt of the structure 23 relative to the axis of rotation 230. This information is indicative of the displacement at a given time. The magnet 231 is suitably placed on a straight line 232 around which the tilt of the structure 23 can be varied. In this way the angle of its magnetic field can tilt exactly with that of the structure 23. Suitably the angular sensor is placed on the straight line 232 around which the tilt of the structure 23 can be varied. More generally the protective casing 7 lies on the straight line 232 around which the structure 23 is tiltable to vary the displacement.

Conveniently, the magnet 231 is made solidly constrained to the structure 23 by means of a magnet holder 233 (and one or more interposed elements), but it could also be positioned directly on the structure 23, for example if it had a support for the magnet 231 made as one piece.

The machine 1 comprises a protective casing 7 of the control unit 5. For example such protective casing 7 is visible outside the housing casing 3. Said protective casing 7 is physically constrained to said housing casing 3. In particular the protective casing 7 is flanged to the housing casing 3. Thus the protective casing 7 is connected by means of connectors, for example threaded, to the housing casing 3.

In an alternative solution the protective casing 7 could be integrated into the housing casing 3.

The detection sensor 6 is placed inside the protective casing 7. Suitably the sensor 6 lies outside the housing casing 3.

Suitably the protective casing 7 contributes to defining the housing casing 3. In fact, the protective casing 7 defines a plug of the housing casing 3 (in fact it occludes an opening of the protective casing 7).

The protective casing 7 also acts as a hydraulic seal of the fluid (typically oil) present in the housing casing 3. Typically at least one gasket is therefore interposed between the casing 3 and the casing 7.

In particular the protective casing 7 comprises two assembled half-shells 71,72. One of such half-shell (in cooperation with at least one gasket 73) acts as a plug for an opening of the casing 3. Said at least one gasket 73 surrounds a mouth of the casing 3 occluded by the casing 7.

At least a part of said protective casing 7 placed at the detection sensor 6 is not ferromagnetic, suitably it is paramagnetic or diamagnetic. For example, the casing 7 is made of aluminium. Suitably the entire protective casing 7 is not ferromagnetic, but suitably paramagnetic or diamagnetic. The use of one or more non-ferromagnetic elements allows a more accurate measurement of the position of the structure 23 (typically determined by the Hall effect sensor).

Advantageously, in the case of a Hall effect sensor, the sensor 6 is less than 10 millimetres away from the magnet 231 solidly constrained to the structure 23 and with which it interacts to have a parameter related to the displacement of the machine 1. In fact, reducing this distance increases the number of magnetic field lines generated by the magnet 231 that hit the sensor 6. Therefore, the measurement is more precise and reliable. In addition, reducing this distance improves the reliability of the measurement also considering that less interferences are possible.

Suitably a zone inside the housing casing 3 and said detection sensor 6 are physically separated by a wall 37 integrated in said protective casing 7 (but it could also be a wall integrated in the casing 3; in this case the gasket 73 would be absent and the protective casing 7 would not act as a plug). Or in any case, said wall 37 is physically interposed between the inner zone of the casing 3 and the sensor 6.

Said wall 37 has a thinned thickness at said detection sensor 6 relative to surrounding zones. This is with the aim of minimizing any interferences in the measurement. In fact, as already explained, in the case of a Hall-effect sensor, it is important to reduce as much as possible the distance between the sensor and the magnet solidly constrained to the structure 23.

The present invention achieves important advantages.

First of all, it allows to optimize the wirings. This is achieved by positioning the detection sensor for detecting a displacement parameter inside the protective casing 7 of the control unit and by positioning the casing 7 close to the casing 3 (machine body). Moreover, the positioning of the protective casing 7 close to the machine body advantageously takes place precisely in a position that facilitates and optimizes the detection of a parameter associated with the tilt of the structure 23 relative to the axis of rotation 230.

The invention as it is conceived is susceptible to numerous modifications and variants, all falling within the scope of the inventive concept characterised thereby. Further, all the details can be replaced with other technically equivalent elements. In practice, all the materials used, as well as the dimensions, can be any whatsoever, according to need.

1. A volumetric variable displacement machine interacting with an operating fluid, said machine being a motor with axial pistons or a pump with axial pistons and comprising:
i) means (2) interacting with the operating fluid;
ii) a housing casing (3) housing means (2) interacting with the operating fluid;
iii) actuating means (4) for regulating a displacement of the machine;
iv) a control unit (5) for controlling the actuating means (4);
v) a detection sensor (6) for detecting a parameter associated with the adopted displacement of the machine and operationally connected to the control unit (5);
characterized in that it comprises a protective casing (7) protecting the control unit (5) that is integrated into or constrained physically on said housing casing (3); said detection sensor (6) being placed inside the protective casing (7).

2. The machine according to claim 1, characterized in that said axial piston motor or said axial piston pump in turn comprises:
a plurality of pistons (21) that are movable forwards and backwards along a common movement direction and are rotatable around an axis of rotation (230) parallel to the movement direction;
a structure with variable tilt (23) relative to the axis of rotation (230) for regulating a stroke of the pistons and thus of the displacement of the machine; the actuating means (4) acting on said structure (23) with a variable tilt to regulate the displacement of the machine (1).

3. The machine according to claim 2, characterized in that said protective casing (7) and/or said sensor (6) are/is intersected by a straight line (232) around which said structure (23) with a variable tilt is tiltable to vary the displacement.

4. The machine according to claim 2, characterized in that the detection sensor (6) comprises/is an angular sensor that detects a variation of the tilt of the structure (23) with a variable tilt relative to the axis of rotation (230).

5. The machine according to claim 4, characterized in that the angular sensor is a Hall effect sensor and interacts remotely with a magnet (231) that is solidly constrained to said structure (23) with a variable tilt to comprise the degree of tilt of the structure (23) with a variable tilt relative to the rotation axis (230).

6. The machine according to claim 5, characterized in that said detection sensor (6) is less than 10 millimetres from said magnet (231).

7. The machine according to claim 1, characterized in that one part of said housing casing (3) placed at the detection sensor (6) and/or said protective casing (7) are not/is not ferromagnetic.

8. The machine according to claim 1, characterized in that said protective casing (7) is outside the housing casing (3) and flanged thereupon.

9. The machine according to claim 1, characterized in that a wall (37) integrated into said housing casing (3) or into said protective casing (7) separates physically:
a zone bounded by the housing casing (3); and
said detection sensor (6).

10. The machine according to claim 9, characterized in that said wall (37) has a thinned thickness at said detection sensor (6) relative to surrounding zones.
